(19) United States
(12) Patent Application Publication
(10) Pub. No.: US 2010/0130129 A1
(43) Pub. Date: May 27, 2010

(54) WLAN and bluetooth harmonization

(76) Inventors: Jue Chang, Plano, TX (US); Yujie Zhu, Frisco, TX (US); Heping Shi, Carrollton, TX (US); Wei Liu, Plano, TX (US); Xinsi Lin, Lewisville, TX (US); Kunquan Sun, Plano, TX (US); Meng Zhao, Plano, TX (US)

Correspondence Address: Law Office of Peter V.D. Wilde, 301 East Landing, Williamsburg, VA, 23185, US

(21) Appl. No.: 12/313,870

(22) Filed: Nov. 25, 2008

(51) Int. Cl. H04B 7/00

(52) U.S. Cl. 455/41.2

(57) ABSTRACT

Described is a WLAN/BT system with improved compatibility. It employs an adaptive algorithm that dynamically optimizes the WLAN data fragmentation size based on the current WLAN data rates such that the fragmented data packets fit the time slots allowed by the BT SCO stream gaps. The algorithm first uses system level information to acquire the concurrent BT traffic types to decide if TDM method needs to be enabled. Then it uses the smoothed WLAN date rate to calculate maximum fragmentation packet size consistent with current overall WLAN traffic.

### FIELD OF THE INVENTION

The present invention relates generally to wireless mobile communication systems. More specifically it relates to collocated wireless local area network (WLAN) and Bluetooth (BT) radio systems that-are designed to operate concurrently with minimal radio frequency (RF) interference.

### BACKGROUND OF THE INVENTION

WLAN and Bluetooth are two wireless communication technologies increasingly used together in small mobile devices for many convenient applications. Both WLAN and BT operate in the same 2.4 GHz ISM (Industrial, Scientific and Medical) frequency band. However, when they are used concurrently in the same vicinity, performance may degrade for both, due to co-band mutual RF interference.

The standard BT adaptive frequency hopping (AFH) algorithm has improved the BT performance significantly by avoiding RF channels occupied by a nearby WLAN. It is essentially a dynamic frequency division multiplex (FDM) scheme. However, AFH does not perform well when BT and WLAB are closely collocated because the radio interference is so strong that the receiving radio is desensitized and not able to receive signals properly. Other algorithms such as active signaling (AS) have been proposed to synchronize radio transmissions in a collaborative time division multiplex (TDM) manner to eliminate the radio interference. Note that a receiving radio will not create radio interference. The AS algorithm is based on using priority signals from the BT radio to determine which radio has priority time slots to transmit and/or receive, thus improving the quality of service (QoS).

A wide variety of BT applications exist. A well known example is a BT mono headset with hands-free profile via SCO (synchronous connection oriented) connection is used in voice over IP (VoIP) through a WLAN link. The TDM algorithm is used in this application for BT audio quality. However, according to the algorithm, the time slot available for WLAN traffic may be too short for WLAN data to pass through at lower data rates, causing interruptions in the VoIP link. This frequently occurs, for example, when a WLAN mobile device is located remote from the WLAN access point (AP), and the data rate is below 11 Mbps (mega bit per sec).

Accordingly, it is desirable to alleviate the above-mentioned problem through the use of new algorithms and embodiments so that WLAN and BT are compatible for all WLAN data rates, and BT audio quality is not impaired by WLAN/BT interference.

### BRIEF STATEMENT OF THE INVENTION

We have developed a WLAN and BT system with improved overall system performance, specifically the Quality Of Service (QoS). It employs an adaptive algorithm that dynamically optimizes the WLAN data fragmentation size based on the current WLAN data rates such that the fragmented data packets fit the time slots allowed by the BT SCO stream gaps. The algorithm first uses system level information to acquire the concurrent BT traffic types to decide if TDM method needs to be enabled. Then it uses the smoothed WLAN date rate to calculate maximum fragmentation packet size consistent with current overall WLAN traffic.

Preferred placement of the algorithm is inside the software driver for the WLAN where it is transparent to the host system where WLAN and BT reside. The algorithm only alters the transmit packet size toward WLAN AP; it will not impact the end-to-end maximum transmission unit (MTU) size. Thus downstream (from AP to WLAN) network throughput performance is not affected if WLAN and BT receiving path is mostly available and not time slotted. This feature is practical since internet traffic is typically asymmetric, and download dominated.

### BRIEF DESCRIPTION OF THE DRAWING

The detailed description will hereafter be described with reference to the accompanying drawings, in which:

FIG. 1 is a diagrammatic representation of a mobile device having a Bluetooth interface and a WLAN interface in accordance with a preferred embodiment.

FIG. 2 is a diagrammatic representation of a wireless network connected to the internet cloud in accordance with a preferred embodiment.

FIG. 3 is a diagrammatic representation of a successful WLAN data packet transmission and acknowledgement reception in the gap between two SCO HV3 packets.

FIG. 4 is a diagrammatic representation of a failed WLAN data packet transmission and acknowledgement reception in the gap between two SCO HV3 packets when active signaling is enabled.

FIG. 5 is a diagrammatic representation of a successful WLAN data packet transmission after it is fragmented into a few data segments.

FIG. 6 is a diagrammatic representation of the MAC layer state machine running on a central processing unit (CPU).

FIG. 7 is a diagrammatic representation of the MAC layer action when BT SPU is turned on and each time the fragment check timer is expired.

FIG. 8 is a diagrammatic representation of the MAC layer action when BT SPU is turned off.

FIG. 9 is a diagrammatic representation of the algorithm for smoothing the date rate.

FIG. 10 is a diagrammatic representation of the algorithm of calculating the fragment size from the smoothed data rate.

FIG. 11 is a diagrammatic representation of how a WLAN data packet reception and acknowledgement transmission share the same frequency and overlap in the time with SCO HV3 packets transmission and reception.

### DETAILED DESCRIPTION OF THE INVENTION

Bluetooth is a short-range radio link intended to replace cables connecting portable and/or fixed electronic devices. It operates at the unlicensed 2.4 GHz Industrial-Scientific-Medical (ISM) band. There are many types of devices using this band, such as notebook computers, cordless phones, baby monitors, garage door remote controls, etc. To avoid interfering with these devices and other local networks, Bluetooth devices send out weak signals (e.g. 1 milliwatt). This limits the transmission range to, e.g., 10 meters or less.

Multiple Bluetooth devices may operate together in a “piconet”, which is coordinated in a master/slave relationship. Among the multiple Bluetooth devices in a piconet there is only one master unit device, the rest are slave unit devices. A device can belong to two piconets simultaneously, serving as slave units in both piconets, or a master unit in one and slave unit in another.

There are two types of connections that can be established between a master unit and a slave unit: the Synchronous Connection-Oriented (SCO) link, and the Asynchronous Connectionless (ACL) link. SCO links provide a circuit oriented service with constant bandwidth based on a fixed and periodic allocation of slots. SCO links use a pair of slots once every two, four or six slots, depending upon the SCO packet chosen for the link. ACL connections provide a packet-oriented service and span over 1, 3 or 5 slots. The master unit controls the traffic on ACL links by employing a polling scheme to divide the piconet bandwidth among the slave units. A slave unit is only allowed to transmit after the master unit has polled it.

Master unit and slave unit communication via the point-to-point Synchronous Connection-Oriented (SCO) link typically operates at a symmetric 64 kbps rate, and is used typically for voice transmission. Because it uses reserved time slots, it can be regarded as a circuit switching link. A master unit can support up to 3 SCO links to one or multiple slave units, while a slave unit can support up to three SCO links to one master unit or up to two SCO links to different master units. Master units transmit at reserved master-to-slave time slots, and slave units respond in the following slave-to-master slot. Unlike ACL packets, SCO packets are not retransmitted.

Bluetooth transmission algorithms use frequency hopping techniques, hopping randomly between typically 79 1-MHz channels 1600 times per second (625 us time slot). Each piconet is synchronized to a specific frequency hopping pattern, so that even different piconets do not interfere with each other. A piconet can either be static or dynamic (changing when devices move in or out).

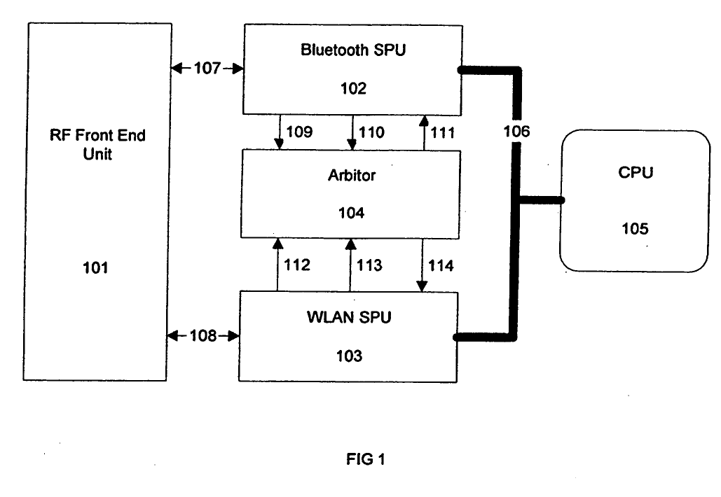

FIG. 1 illustrates a mobile device including a Bluetooth SPU (signal processing unit) 102, a WLAN SPU 103, an arbiter 104, signaling interfaces between the Bluetooth SPU and the arbiter 109, 110, and 111, signaling interfaces between the WLAN SPU and the arbiter 112, 113, and 114, an RF front end 101 which connects to the Bluetooth SPU through RF interface 107 and to the WLAN SPU through RF interface 108, and a central processing unit (CPU) 105 which connects both the Bluetooth SPU and the WLAN SPU through a host interface bus 106.

In one preferred embodiment RF signal isolation between the interface 107 and the interface 108 is better than 20 dB.

In accordance of one aspect of the embodiment the interface 109, labeled as BT_REQ, is used for the Bluetooth SPU to request for transmit. The interface 110, labeled as BT_STATE, is used for the state information from the Bluetooth SPU which may include the priority and transmit/receive direction. The interface 111, labeled as BT_GRANT, is used to grant the transmit request to the Bluetooth SPU from the arbiter. The interface 112, labeled as WL_REQ, is used for the WLAN SPU to request for transmit. The interface 113, labeled as WL_STATE, is used for the state information from the WLAN SPU, which may include the priority and transmit/receive direction. The interface 114, labeled as WL_GRANT, is used to grant the transmit request to the WLAN SPU from the arbiter.

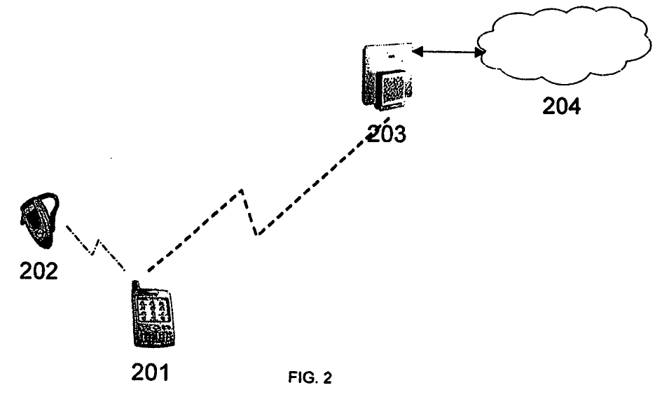

FIG. 2 illustrates a wireless local area network (WLAN) including mobile devices such as PDA/smart phone supporting WLAN and Bluetooth 201, Bluetooth headsets 202, and a WLAN AP (access point) 203 which is connected to the internet 204 though a WAN (wide area network) interface.

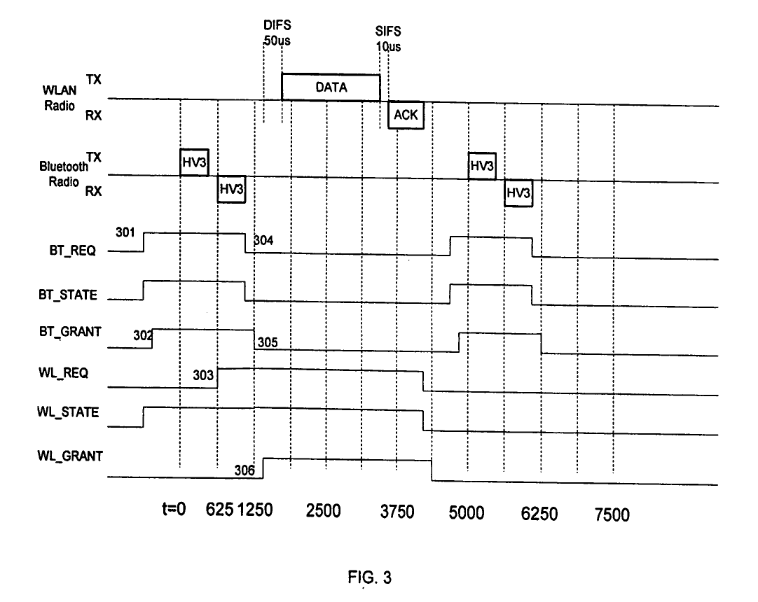

FIG. 3 illustrates a successful WLAN data packet transmission and acknowledgement reception using the gap between two SCO HV3 packets. HV3 packets are high-quality voice packets that carry 30 information bytes. Packets are sent every six time slots. Other types of packets may be substituted.

In the example shown in FIG. 3, the gap length is about 2.5 ms, which is long enough for a packet with 1500 bytes transmitting at 11 Mbps, but not long enough for a 1500 bytes packet transmitting at 1 Mbps.

The successful transmission in FIG. 3 is demonstrated by the following sequence.

When the BT SPU has a voice packet to send it raises the signal BT_REQ (action 301) and sends out the signal BT_STATE. The arbiter makes a decision based on all its inputs, and raises the signal BT_GRANT (action 302 in this example). After the transmission and reception are completed the BT SPU lowers the signal BT_REQ (action 304). The arbiter does not raise WL_GRANT (action 305) until then even though the WLAN SPU has earlier raised the signal WL_REQ (action 303). The above process repeats itself after the WLAN data packet transmission and acknowledged reception.

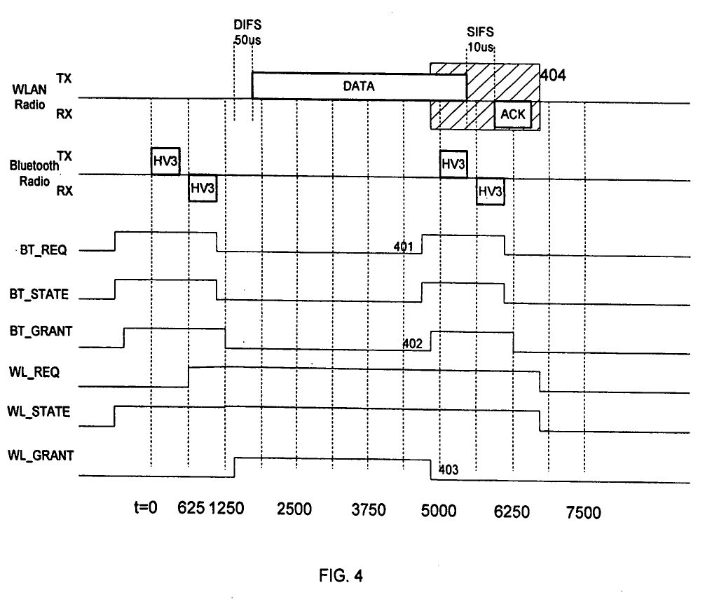

FIG. 4 illustrates a failed WLAN data packet transmission and acknowledged reception in the gap between two SCO HV3 packets due to a data packet that is too long for the gap between Bluetooth HV3 packets. The failed transmission sequence is as follows.

During the transmission and reception of WLAN data packet, a BT_REQ is raised by the BT SPU (action 401) and the arbiter grants it because BT has higher priority in this example (action 402). At the same time the arbiter de-asserts WL_GRANT (action 403). The remaining part of the data packet is not transmitted. The shadowed part 404 represents the failed part of the transmission. This happens regularly when the mobile device is far away from the AP and data rate is dropped to below 5.5 Mbps.

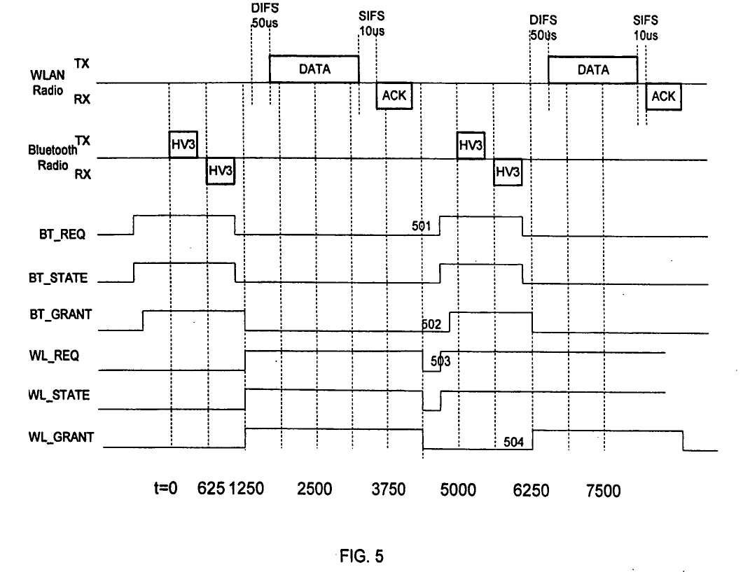

FIG. 5 illustrates a preferred embodiment of this invention which resolves the issue just discussed. Depending on the data rate of the packet pending for the transmission, WLAN SPU decides the fragmentation threshold such that one fragment of the data packet could be sent out and the acknowledgement frame can be received in the current gap. After the current fragment is sent and acknowledged, WLAN SPU asserts WL_REQ immediately instead of sending next fragment after SIFS (10 us). The arbiter will decide if the request could be granted considering if there is enough time before next high priority BT_REQ is expected. One way to avoid collisions is to maintain a fixed time gap like 3.75 ms for SCO connection. Another way is to expand BT_STATE such that it includes the remaining idle time expected. In the example illustrated in FIG. 5 BT_REQ 501 and WL_REQ 503 are asserted about same time and BT SPU is granted for the access, but WLAN SPU is denied access until BT SPU completes transaction 504. This sequence of access will occur even though WL_REQ is asserted earlier, because there is insufficient time for another fragment transmission and acknowledgement reception.

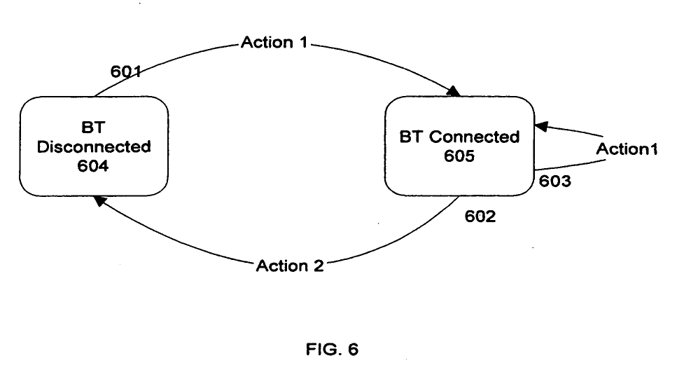

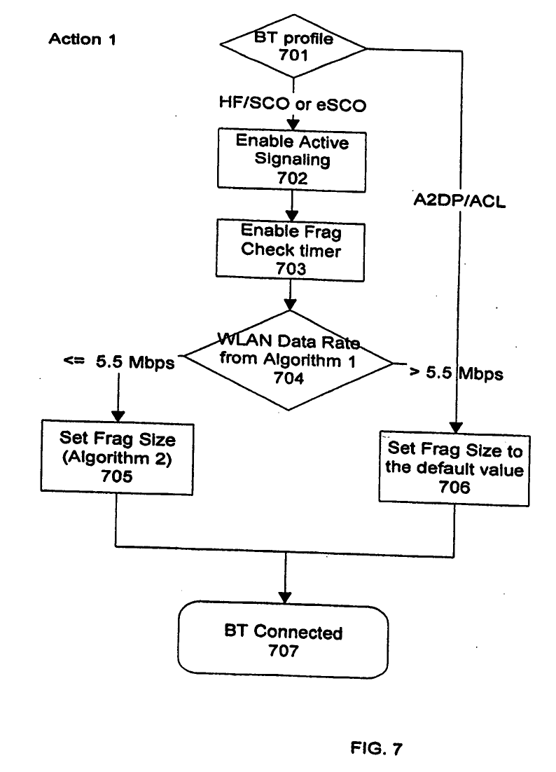

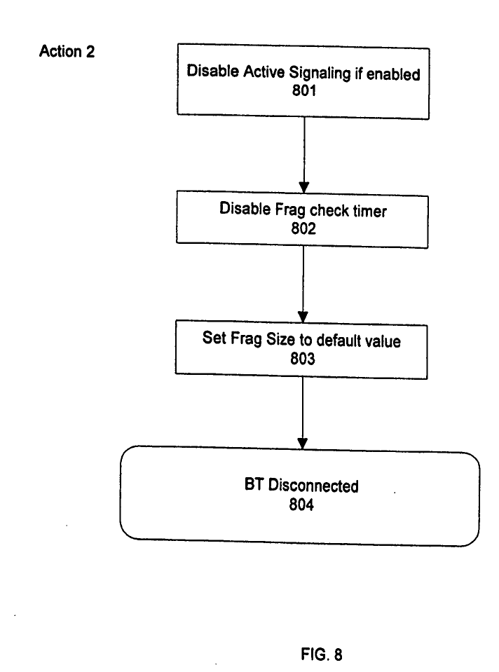

FIG. 6 describes a MAC layer state machine related to this invention. The initial state after powering up has BT Disconnected 604. When BT SPU is turned on 601 Action 1 described in FIG. 7 is taken and the state BT connected is entered 605. When the fragment check timer expires, Action 1 is performed. When BT SPU is turned off 602, Action 2 described in FIG. 8 is taken and state BT Disconnected is entered 604.

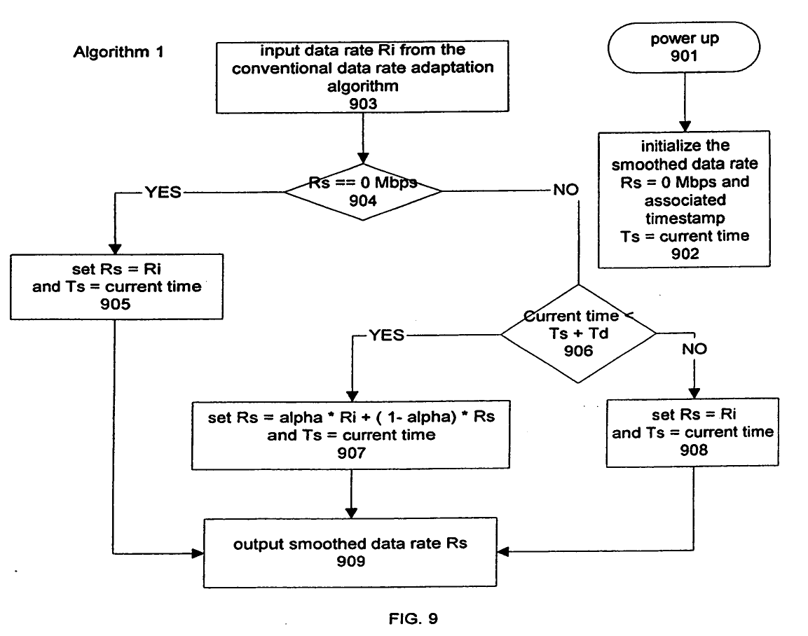

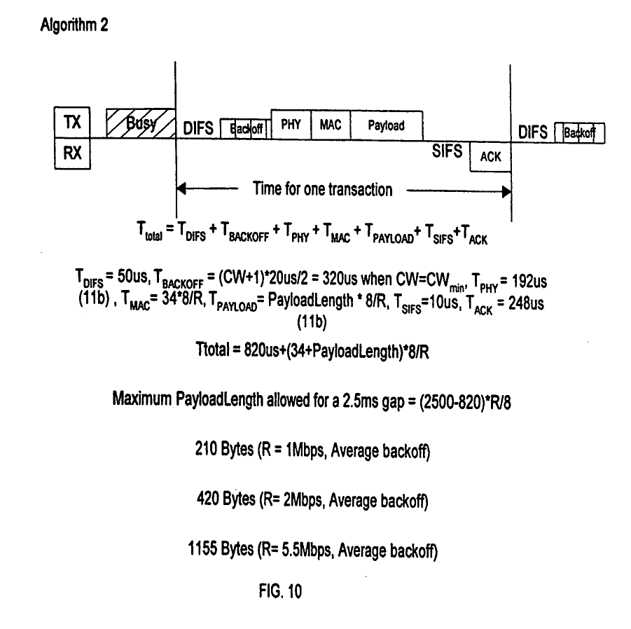

FIG. 7 describes Action 1 in detail. First the current BT profile is checked 701. If it is Headset Profile (HSP), Hands-Free Profile (HFP) and other using SCO or eSCO connection, Active Signaling is enabled 702 and a fragmentation check timer is enabled 703. Then a smoothed data rate using the algorithm described in FIG. 9 (Algorithm 1 hereafter), or an equivalent functional algorithm, is calculated 704. If the smoothed data rate is less than or equal to 5.5 Mbps, an algorithm (Algorithm 2 hereafter) described in FIG. 10 (Algorithm 2 hereafter), or an equivalent functional algorithm, is used to calculate the fragmentation threshold size 705. If the smoothed data rate is greater than 5.5 Mbps or the current BT profile is Advanced Audio Distribution Profile (A2DP) or another profile not using SCO or eSCO connection, the fragmentation threshold size is reset to the default value 706. Finally BT Connected state is entered 707.

FIG. 8 describes Action 2 in detail. First, Active Signaling is disabled 801 and the fragmentation check timer is stopped 802. Then the fragmentation threshold size is reset to the default value 803. Finally BT connected state is entered 804.

FIG. 9 describes Algorithm 1 in detail. The purpose for this algorithm is to smooth the data rate and fragmentation threshold to avoid pin pong effect. Input data rate is from the conventional data rate adaptation algorithm which may be Receive Signal Strength Indicator (RSSI) or Packet Error Rate (PER) based. This algorithm is an example only of algorithms useful for this function. Algorithm 1 is comprised of two basic elements. One element is alpha filer (ALPHA value of less than 1) which gives a weight ALPHA to the freshest input value and (1-ALPHA) to the average of the oldest input. The other element is that the algorithm is real time based. The filtered output value will be discarded if it is too old and the filtering will restart from the latest input value.

FIG. 10 describes Algorithm 2 in detail. This algorithm defines the fragmentation threshold at 176 Bytes, 386 Bytes, and 1121 Bytes respectively for the date rate of 1 Mbps, 2 Mbps, and 5.5 Mbps.

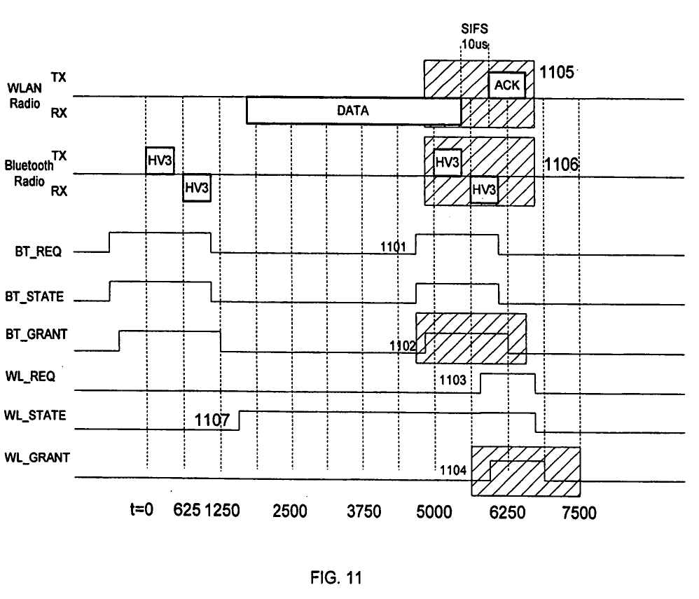

FIG. 11 is a diagrammatic representation of how a WLAN data packet reception and acknowledgement transmission share the same frequency and overlap in the time with SCO HV3 packets transmission and reception. It is known that AP doesn't know that the mobile device has a SCO connection active, and it will continue to transmit to the mobile device with normal fragmentation size. When the packet date rate is low (<=5.5 Mbps), the WLAN data packet will overlap with BT SCO packets. Particularly harmful is that BT will transmit in the occupied band of WLAN channel. The probability of that is about 28 percent. Use of an adaptive frequency hopping algorithm will help to avoid that in-band interference. Out-of-Band interference in WLAN reception remains an issue. Isolation between the interface 107 and 108 in FIG. 1 is important to help reduce that interference. Current RF technology limits the effectiveness of that isolation.

When a basic WLAN connection is active at the same time an SCO connection is active, use of the invention provides tradeoff between BT quality and WLAN quality. While WLAN SPU is receiving a packet, it notifies the arbiter its state by asserting WL_STATE 1107. This state information facilitates the decision for the next BT_REQ. A random function uniformly distributed between 0 and 1 and threshold D_{threshold}<1 may be used to implement the trade-off. When BT_REQ is asserted, a random number is generated and compared with D_{threshold}, and BT_GRANT will be asserted only when the generated value is greater that D_{threshold}.

In the foregoing description the emphasis is on Bluetooth devices operating with BT data packets in a WiFi based network (WLAN). However, the invention may be applied to simultaneous operation of other kinds of devices in a WLAN environment. In the broader sense the devices operate in wireless personal area networks (WPANs) and the data packets may be referred to as WPAN data packets. A WPAN is a wireless computer network used for communication among computer devices (including telephones and personal digital assistants) close to one person. The reach of a WPAN is typically less than 10 meters. WPANs can be used for communication among the personal devices themselves (intrapersonal communication), or for connecting to a higher level network and the Internet (an uplink). Technologies for WPANs include, in addition to Bluetooth, IrDA, UWB, Z-Wave and ZigBee. WPANs may also be referred to by the standard under which they operate, i.e., IEEE standard 802.11. The 802.11 standard has many variations, amendments and modifications. Generically, WLANs are referred to here as networks operating according to IEEE standard 802.11x, where x refers to known and future variations of standard 802.11.

Likewise, devices suitable for use with the invention may be referred to as personal communications devices operating with the IEEE standard 802.15x, or equivalents.

RF interference between an operating WPAN device and an operating WLAN occurs when the WPAN RF antenna and the WLAN RF antenna are co-located. Operating means communicating. Co-located means that one or the other is within the effective range of the other. In the usual case these two entities are combined in a single device that has an RF transceiver for the WLAN communication and an RF transceiver for the WPAN communication. The two RF transceivers may share switches, indicator lights, circuits or circuit elements. An RF front end system, such as that shown at 101 in FIG. 1, may comprises separate antennas for the WPAN interface and the WLAN interface respectively, or these interfaces may share an antenna. In general the method involves simultaneously communicating between a collocated Wireless Local Area Network (WLAN)/Wireless Personal Area Network (WPAN) device and both a Wireless Network (WPAN) transceiver and a Wireless Local Area Network (WLAN) transceiver. In the preferred embodiment the WPAN device and the WPAN network is BT.

Various additional modifications of this invention will occur to those skilled in the art. All deviations from the specific teachings of this specification that basically rely on the principles and their equivalents through which the art has been advanced are properly considered within the scope of the invention as described and claimed.

1. A method for a collocated Wireless Local Area Network (WLAN) and Wireless Personal Area Network (WPAN) device to simultaneously communicate with a Wireless Personal Area Network (WPAN) device and a Wireless Local Area Network (WLAN), the method comprising:
a) communicating with the WLAN using a WLAN interface;
b) communicating with the WPAN device using a WPAN interface;
c) using a RF antenna/front end system to communicate with the WPAN interface and the WLAN interface simultaneously;
d) receiving WLAN data packets and WPAN data packets simultaneously, wherein the WPAN data packets comprise WPAN data packets having WPAN data rates with a time gap between the WPAN data packets;
e) determining the size of the time gap between the WPAN data packets;
f) determining the WLAN data rate;
g) determining a WLAN data packet fragment size based on the time gap between WPAN data packets and the WLAN data rate; and
h) transmitting WLAN data packet fragments within the time gap between two consecutive WPAN data packets.

2. The method of claim 1 wherein the WPAN device is a Bluetooth (BT) device with active BT profiles, and the WPAN data packets are BT data packets.

3. The method of claim 2 wherein the WLAN data packet fragment size is based in addition on the active BT profiles.

4. The method of claim 3, wherein active BT profiles comprise Headset Profiles, Hands-Free Profiles and other profiles using SCO/eSCO connections.

5. The method of claim 1, wherein the data rates comprise output from a data rate smoothing algorithm.

6. The method of claim 5 wherein inputs into the data rate smoothing algorithm are from a conventional data rate adaptation algorithm.

7. The method of claim 2 wherein the BT data packets comprise high priority WPAN data packets.

8. The method of claim 7 wherein the WLAN data packets are transmitted only in the time gap between high priority BT data packets.

9. The method of claim 1 wherein the method is implemented by a software algorithm placed inside a software driver for the WLAN.

10. The method of claim 1 wherein steps e) and f) are performed and step h) is performed only if the result of steps e) and f) meet predetermined criteria.

11. A method for simultaneously communicating with a Wireless Personal Area Network (WPAN) device and the access point of a Wireless Local Area Network (WLAN), the method comprising selectively modifying WLAN data being transmitted toward the access point using the method of claim 1.
